(19) United States
(12) Patent Application Publication
(10) Pub. No.: US 2025/0215131 A1
(43) Pub. Date: Jul. 3, 2025

(54) POLYMER/CELLULOSE NANOCRYSTAL-BASED NANOCOMPOSITE AND METHOD OF MAKING SAME

(71) Applicants: Douglas FOX, Reston, VA (US); Whirang CHO, Gaithersburg, MD (US); Jeremiah WOODCOCK, Gaithersburg, MD (US)

(72) Inventors: Douglas FOX, Reston, VA (US); Whirang CHO, Gaithersburg, MD (US); Jeremiah WOODCOCK, Gaithersburg, MD (US)

(21) Appl. No.: 18/875,249

(22) PCT Filed: Jun. 16, 2023
(86) PCT No.: PCT/US2023/025588

§ 371 Date: Dec. 16, 2024

Related U.S. Application Data
(60) Provisional application No. 63/352,817, filed on Jun. 16, 2022.

(51) Int. Cl. C08F 251/02; C08F 222/10; C08L 1/16; C08L 33/12; C08L 67/04

(52) U.S. Cl. CPC C08F 251/02; C08F 222/102; C08L 1/16; C08L 33/12; C08L 67/04

(57) ABSTRACT

A cellulose-polymer nanocomposite is provided by reacting a polymer monomer in the presence of with a cellulose-polymer precursor. The precursor may include an azonitrile-based initiator grafted to a cellulose nanomaterial. The monomer and the precursor are reacted together in an aqueous solvent, in free monomer solution, or in an extruder. In one embodiment, the azonitrile initiator is 4,4′-Azobis (4-cyanovaleric acid), 4,4′-Azobis (4-cyanopentanoic acid), 1,1′-azodi (hexahydrobenzonitrile), oorr 2,2′ azodi(2-methyl-butyronitrile), azobisisobutyronitrile or Val-azobisisobutyronitrile.

### RELATED APPLICATIONS

This application claims priority to U.S. Provisional Application No. 63/352,817, filed Jun. 16, 2022, entitled POLY(METHYL METHACRYLATE)/CELLULOSE NANOCRYSTAL-BASED NANOCOMPOSITE AND METHOD OF MAKING SAME, which is incorporated herein in its entirety.

### ACKNOWLEDGMENT OF GOVERNMENT SUPPORT

This invention was made with government support under Grant Award No. 70NANB18H225 awarded by the National Institute of Standards Technology (NIST). The government has certain rights in the invention.

### RELATED TECHNOLOGY

This application relates to cellulose nanomaterial polymer nanocomposites and methods of making the same. Specifically, the application relates to the use of an azonitrile initiator grafted to a cellulose nanomaterial to form a nanocomposite precursor and using that precursor to graft on to suitable monomers, such as methyl methacrylate, to form a cellulose nanomaterial polymer nanocomposite.

### BACKGROUND

Applications of cellulose nanomaterials (CNMs) in polymer matrixes are driven by excellent sustainability as well as mechanical and barrier attributes of CNMs. Many research efforts have been conducted to enhance their compatibility with polymers. However, interfacial compatibility between cellulose nanocrystals and polymer matrix is particularly challenging due to the hydrophilicity of CNMs.

There are a number of obstacles to the commercial development of CNM reinforced polymer nanocomposites. When the CNMs are dried, their hydrophilic nature and strong hydrogen bonds make dispersion difficult in any solvent other than the very polar, aprotic ones, such as dimethylformamide or dimethylsulfoxide. Even for water, stable dispersion is achieved only if the dried CNCs contain at least 4 wt % water or if they are neutralized to the sodium form crystals. And, without the electrostatic repulsion, uncharged cellulose nanofibers (CNF) cannot be dried and resuspended in any solvent without some loss in nano-character. Another challenge is that the use of cellulose tends to increase water absorption, which can lead to increased molding and de-bonding from the polymer matrix.

There have been a number of approaches to overcome these obstacles. Most of the disadvantages are due to the presence of mobile protons and the strong hydrogen bonding between adjacent cellulose chains. A common approach to overcome these dissimilar intermolecular forces is to graft polymers onto the cellulose chain, which shield the hydroxyls and increase the hydrophobicity of the cellulose. The grafting technique almost always requires liquid-liquid extractions, heating, and purification steps, significantly adding operating costs to any scale up process.

There are three common methods for attaching polymers to the surface of the cellulose nanomaterials. “Graft onto” techniques, where a preformed polymer with a reactive handle is used to covalently link to cellulose, “graft from” techniques, where a monomer is covalently bonded to the surface of the cellulose, or “in-situ polymerization”, where a monomer is grafted to the cellulose surface and is co-polymerized with free monomer. The graft in all three of these methods can be at a hydroxyl, end-group aldehyde, or charged group on the surface of the cellulose. An example of the charged group is the formation of sulfate half esters on the surface of the cellulose during sulfuric hydration when forming cellulose nanocrystals. Attaching to a charged cellulose particle adds additional challenges, because the reactive handle, such as isocyanate, isothiocyanate, or acyl halides, preferentially react at some of these charge sites (e.g. sulfate). Although this might not matter for all applications, the inability to control the reaction site or extent of reaction adds challenges to processability and quality control.

An initiator may be attached over a monomer due to its versatility, controllability, and ability to form well dispersed masterbatches. When a monomer is attached to cellulose for polymer from cellulose grafting, the linker is fixed. In addition, the reactivity of the bound monomer may differ significantly from the free monomer due to steric and interfacial differences. And, the variability of polymer chain lengths attached to the cellulose is likely to be high.

Although ATRP initiators (such as 2-bromoisobutyryl bromide) have been attached to cellulose to initiate graft from composites, these initiators are water sensitive, require solvent exchange into nonaqueous solvents, and typically use Cu(I) or other heavy metal compounds. Charge transfer agents (such as 4-Cyano-4-(phenylcarbonothioylthio)pentanoic acid) have also been attached to cellulose to provide RAFT polymerizations. The ester attachments are not pH stable and solubility issues can arise.

Moreover, most attachment chemistries require the removal of water. Ring opening polymerization, such as lactone-based polyesters, can be initiated by hydroxyl groups, which is why they have been investigated for cellulose grafting. This requires the removal of water, which would also open the lactone rings. It would be useful to develop a method that eliminated the need for water removal.

Surface initiated controlled radical polymerization may be used for grafting an initiator to the surface of cellulose. However, commonly known methods, such as grafting 2-bromoisobutyryl bromide onto cellulose requires the use of aprotic solvents. Since it is a nucleophilic addition using an organohalide, it will react with water or alcohol, necessitating the use of an aprotic solvent. In addition, many of the initiators grafted previously require ionic, heavy metal, or organometallic based catalysts for either grafting or for the polymerization reaction. These catalysts can be expensive, are often toxic, and are difficult to remove after polymerization. It would be useful to develop a method that did not require these catalyst materials.

Free-radical polymerization may also be used. However, the extent of polymerization is less controllable and polymer dispersity index is typically broader. Most methods involve the formation of free radicals at the hydroxyl groups using oxidizing species. Potassium persulfate, ammonium persulfate, sodium bisulfate, and ceric ions have all been used to generate free radicals along the surface of cellulose to initiate polymerization reactions in aqueous solution. The free radical location and density is difficult to control, and it is generally quenched when removed from aqueous solution. In addition, the presence of the salts complicates the purification of the polymerized nanocomposite.

### SUMMARY

A cellulose-polymer nanocomposite is provided by reacting a polymer monomer in the presence of with a cellulose-polymer precursor. The precursor may include an azonitrile-based initiator grafted to a cellulose nanomaterial. The monomer and the precursor are reacted together in an aqueous solvent, in free monomer solution, or in an extruder. In one embodiment, the azonitrile initiator is 4,4′-Azobis (4-cyanovaleric acid), 4,4′-Azobis (4-cyanopentanoic acid), 1,1′-azodi (hexahydrobenzonitrile), or 2,2′ azodi(2-methylbutyronitrile), azobisisobutyronitrile or Val-azobisisobutyronitrile.

In one embodiment, a thermal, free radical initiator-grafted modified cellulose-polymer nanocomposite precursor composition includes an azonitrile-based initiator grafted to a cellulose nanomaterial; wherein the cellulose nanomaterial is selected from the group consisting of an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups.

The azonitrile initiator compound may be 4,4″-Azobis (4-cyanovaleric acid), 4,4′-Azobis (4-cyanopentanoic acid), 1,1′-azodi (hexahydrobenzonitrile), or 2,2′ azodi(2-methylbutyronitrile), azobisisobutyronitrile or Val-azobisisobutyronitrile.

In another embodiment, a cellulose-polymer nanocomposite is made by reacting a polymer monomer with a cellulose-polymer precursor comprising an azonitrile-based initiator grafted to a cellulose nanomaterial, wherein the monomer and the precursor are reacted together in an aqueous solvent, in free monomer solution, or in an extruder; and the cellulose nanomaterial is selected from the group consisting of an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups. The polymer monomer may be a vinyl monomer, an acrylate monomer, or a combination thereof. In one embodiment, the polymer monomer is selected from butyl acrylate, methyl methacrylate, hydroxyethyl methacrylate, styrene, vinyl chloride, vinyl esters, acrylic acid, methyl acrylate, ethyl acrylate, 2-chloroethyl vinyl ether, 2-ethylhexyl acrylate, trimethylolpropane triacrylate, and combinations thereof.

In another embodiment, the nanocomposite is further combined with a second polymer in a melt extruder. The second polymer may be polymethylmethacrylate, polystyrene, poly(lactic acid), polycarbonate, polypropylene, or poly(butylene succinate).

In yet another embodiment, a method of making a modified cellulose-polymer nanocomposite precursor composition includes providing an azonitrile-based initiator grafted to a cellulose nanomaterial. The method further includes combining an aqueous solution of never dried cellulose nanomaterials and an acidic solution containing an activated azonitrile initiator; and heating the combination to form the modified cellulose-polymer nanocomposite precursor. The cellulose nanomaterial in solution may be selected from the group consisting of an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups. And, the azonitrile initiator may be 4,4′-Azobis (4-cyanovaleric acid), 4,4′-Azobis (4-cyanopentanoic acid), 1,1′-azodi (hexahydrobenzonitrile), or 2,2′ azodi(2-methylbutyronitrile), azobisisobutyronitrile or Val-azobisisobutyronitrile.

### DESCRIPTION OF THE DRAWINGS

FIG. 1 is a graph of the Fourier-transform infrared spectroscopy (FTIR) absorption patterns over the wavenumber range of 2000-4000 cm−1 for CNF alone and a sulfated AIBN-CNF precursor, prepared as in Example 1.

FIG. 2 is a graph of the Fourier-transform infrared spectroscopy (FTIR) absorption patterns over the wavenumber range of 1000-2250 cm−1 for CNF alone and a sulfated AIBN-CNF precursor, prepared as in Example 1.

FIG. 3 is a graph of the Fourier-transform infrared spectroscopy (FTIR) absorption patterns over the wavenumber range of 2000-4000 cm−1 for MD alone (top line), AIBN-MD precursor, prepared as in Example 2 (middle line), and AIBN alone (bottom line).

FIG. 4 is a graph of the Fourier-transform infrared spectroscopy (FTIR) absorption patterns over the wavenumber range of 550-2250 cm−1 for MD alone (with a first large peak at about 1000), AIBN-MD precursor, prepared as in Example 2 (with a first large peak at about 1800), and AIBN alone (bottom line).

FIG. 5 is a graph of the Fourier-transform infrared spectroscopy (FTIR) absorption patterns over the wavelength range (nm) of 500-4000 for NaCNC alone, PMMA alone, and a sulfated CNC-PMMA nanocomposite, prepared as in Example 4.

FIG. 6 is a graph comparing the rate of heat flow as temperature increases for CNC-PMMA composite prepared without the AIBN initiator (control) and the AIBN-prepared sulfated CNC-PMMA nanocomposite prepared according to Example 4.

FIG. 7 is a graph comparing the loss of mass (%) as temperature increases for CNC-PMMA composite prepared without the AIBN initiator (control), CNC alone, PMMA alone, and the AIBN-prepared sulfated CNC-PMMA nanocomposite prepared according to Example 4.

FIG. 8 is a derivative thermogravimetry graph comparing how the rate of material weight changes upon heating plotted against temperature for CNC-PMMA composite prepared without the AIBN initiator (control), CNC alone, PMMA alone, and the AIBN-prepared sulfated CNC-PMMA nanocomposite prepared according to Example 4.

FIGS. 9(a)-(d) are optical images (40×) of extruded samples of sulfated CNF-Pinner in PMMA. (a) CNF-Pinner+PMMA, (b) CNF-Pinner soaked in MMA+PMMA, (c) CNF-Pinner-DEGMA+PMMA, (d) unextruded CNF-Pinner-DEGMA.

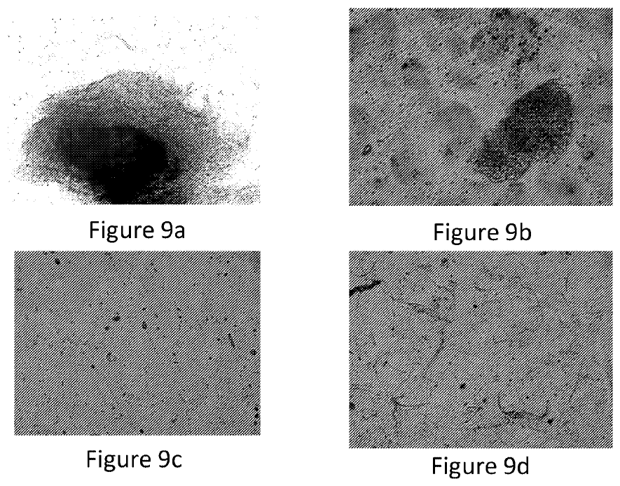

### DESCRIPTION

A method for making polymer/cellulose nanocomposites by attaching a free radical initiator to the surface of cellulose nanomaterials before it is combined with the polymer is disclosed. It should also be understood that the method may also be used to attach other carbohydrate materials, such as cellulose, chitosan, dextrins, cyclodextrins, maltodextrins, etc., to a free radical initiator for use as described herein. Nanocomposites made using this method exhibit increased uniform dispersion of the nanomaterials within the polymer matrix, increased optical transparency, and a unique grafting density. Moreover, the reaction may be performed in the an aqueous environment.

The method disclosed includes (a) a free radical, thermal initiator that may be used for a wide array of polymers; (b) the use of a 2-step, aqueous reaction; (c) polymerization that produces a masterbatch with both cellulose grafted and free polymer; (d) grafted cellulose that can be used in “graft from”, in-situ polymerization, and reactive extrusion processes; (e) use of aqueous monomers in a single pot process that leads to cellulose-polymer nanocomposite that can be filtered, air-dried, and extruded with other polymers; and (f) CNM which can be any form (CNF, CNC, uncharged, charged), with controlled attachment at the surface hydroxyls.

### Cellulose Nanomaterials

There are many forms of cellulose nanomaterials (CNM) that may be used in the cellulose-polymer nanocomposite. They are broadly classified as either cellulose nanofibrils (CNF) or cellulose nanocrystals (CNC), depending on their length and rigidity. CNF are typically several mm long with an average diameter less than 20 nm. They contain large amorphous segments, making them flexible. They entangle quite readily and undergo irreversible aggregation when the water content drops below 85% to 90% (by mass). Oxidation with TEMPO (i.e. 2,2,6,6-Tetramethylpiperidine 1-oxyl, 2,2,6,6-Tetramethyl-1-piperidinyloxy, free radical (C₉H₁₈NO)) and sodium chlorite introduces carboxyl groups along the cellulose chain, leading to the formation of aqueous gels at low concentrations (around 1% by mass or greater). Suitable forms of CNM may be acquired from the University of Maine (CNF), CelluForce NCC (sulfated CNC), Forest Products Society (sulfated CNCs), Anomera (carboxylated CNC), BlueGoose (carboxylated CNCs), Sappi Valida, and TEMPO-CNF.

CNC are shorter (typically less than 1 mm) and are relatively straight and rigid. They are most often formed through acid hydrolysis, and their length varies depending on their source and level of hydrolysis. Hydrolysis using an oxidizing acid (such as sulfuric, phosphoric, or nitric acid) introduces half esters along the cellulose chain. The most common charges on cellulose are sulfate half esters, carboxyl groups, or phosphate half esters. The charges improves colloidal stability of the cellulose through electrostatic repulsion. When formed, the charges are usually paired with a proton. Replacing the proton with an alkali metal through neutralization leads to CNC that can be dried and redispersed in water with very little added energy.

In one embodiment, the CNM may be an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups

### Nitrile Initiators

The method disclosed uses a Pinner reaction to activate an azonitrile initiator, leading to ester formation with hydroxyls without the side reactions with charged groups that might be present on the cellulose.

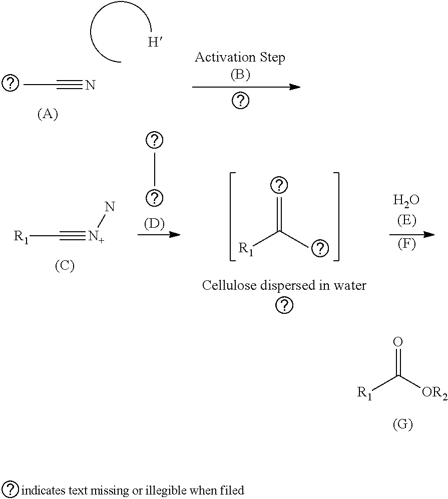

In one embodiment (A) an azonitrile initiator, such as azobisisobutyronitrile or Val-azobisisobutyronitrile, 4,4′-Azobis(4-cyanovaleric acid, 4,4′-Azobis(4-cyanopentanoic acid), 1,1′-azodi(hexahydrobenzonitrile), or 2,2′ azodi(2-methylbutyronitrile), is dissolved in a small amount of a water soluble organic, such as tetrahydrofuran (THF) or N-methylpyrrolidone (NMP). In one embodiment, R₁ may be broadly defined to include any form of an AIBN derivative. For example, R₁ may be C(CH₃)₂N═NC(CH₃)₂CN or C(CH₃)(C₂H₄COOH)═NC(CH₃)(C₂H₄COOH)CN. The solvent must be able to dissolve electrolytes, at least sparingly.

A strong acid (B), such as sulfuric, triflic, tosylic, or trifluoracetic acid is added to the nitrile. Care must be taken to avoid incompatibilities, such as the reaction between NMP and oxidizing acids, such as sulfuric acid. The mixture is stirred for up to an hour to activate the nitrile (C). The mixture is then added to an aqueous solution of never dried cellulose (D) to form a functionalized cellulose material (E), where R₂ may be a form of cellulose (C₆H₁₀O₅)ₙ, where n=300-10,000. A dilute cellulose solution, such as less than 4% CNC, less than 2% CNF, and less than 1% TEMPO-CNF may is beneficial, as some crosslinking and thickening is expected to occur.

(F) After reacting for up to 24 hours, the resulting modified cellulose precursor material (G), including the nitrile initiator, may be purified by filtration, dialysis, or centrifugal washing. Tangential flow filtration can minimize pore clogging during filtering. The modified cellulose precursor can be stored in aqueous solution or freeze dried for use in nonaqueous media.

In one embodiment, cellulose-polymer nanocomposites may then be prepared by in-situ polymerization or reactive extrusion. Unlike with many known cellulose materials,—in-situ polymerization can now be performed in water, in a nonaqueous solvent, or as an emulsion.

### Polymer Monomers

In one embodiment, reacting the modified cellulose precursor (G) in water with a water soluble monomer, such as di(ethylene glycol) methyl ether methacrylate, methyl methacrylate, etc., produces well dispersed polymer-cellulose nanocomposites than can be filtered, air dried, and melt-blended with hydrophobic polymers.

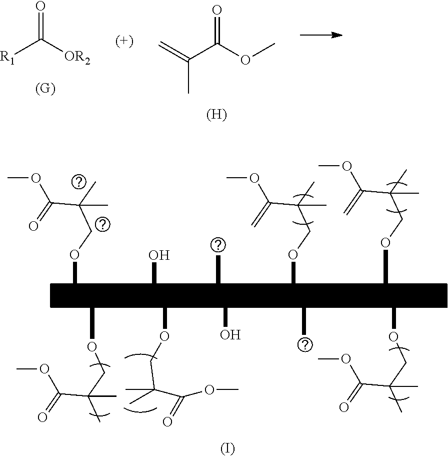

As shown above, an amount of the dried modified cellulose precursor (G) can then be added to a polar aprotic solvent to help facilitate dispersion and further combined with methacrylate monomers (H) to form polymers (I) grafted from the cellulose (G). It should be understood that monomers useful for this process may include those monomers capable of being activated through a free radical process, such as vinyl monomers (styrene, vinyl chloride, etc.) and acrylate monomers (butyl acrylate, methyl methacrylate, hydroxyethyl methacrylate, etc.).

Most of the bonded nitrile initiator will not be crosslinked between two cellulose chains. And, upon thermal activation (i.e. by heating to 80° C. and reacting overnight), two initiators are formed; one on the modified cellulose precursor and one free in solution. This results in a well-blended cellulose polymer nanocomposite between the polymerized polymer and polymer grafted from the cellulose material. A similar cellulose polymer nanocomposite can be prepared without solvent using a reactive extruder. With the proper mixing and shearing zones, the cellulose can be evenly dispersed throughout the cellulose-polymer nanocomposite.

### EXAMPLES

### Example 1: AIBN-CNF

In one example, 4,4′-Azobis(4-cyanovaleric acid) (0.434 g) is added to tetrahydrofuran (5 mL) and stirred until dissolved. Triflic acid (300 mL) is added and stirred for 1 hr to activate the AIBN. The mixture is added to an aqueous solution containing sulfated cellulose nanofibers (50 mL, 2% by mass CNF). The solution is stirred overnight to form a sulfated AIBN-CNF precursor. The precursor is transferred to 10,000 Da dialysis tubing and dialyzed against deionized water until the dialysis water tests pH neutral.

### Example 2: AIBN-MD

In one example, 4,4′-Azobis(4-cyanovaleric acid) (AIBN) (0.434 g) is added to tetrahydrofuran (5 mL) and stirred until dissolved. Triflic acid (300 mL) is added and stirred for 1 hr to activate the AIBN. The mixture is added to an aqueous solution containing maltodextrin (MD), n=4-7 (50 mL, 2% by mass MD). The solution is stirred overnight to form a sulfated AIBN-MD precursor. The precursor is transferred to 1,000 Da dialysis tubing and dialyzed against deionized water until the dialysis water tests pH neutral.

### Example 3: Sulfated CNF-DEGMA-PMMA

In this example, a valeric acid form of AIBN and trifluoromethanesulfonic acid were added to water. This mixture was added to a 10% slurry of sulfated cellulose nanofibrils and reacted overnight to form a sulfated cellulose precursor (AIBN-CNF). The excess reactants were removed by dialysis. The inhibitor in di(ethylene glycol) methyl ether methacrylate (DEGMA) is then removed by running the DEGMA through a column with neutral alumina.

The uninhibited DEGMA (360 mL) is then added to the aqueous solution of the sulfated AIBN-CNF precursor (10.0 g, 1.8% by mass AIBN-CNF) in a round bottom flask. The flask is heated to 80° C. and left to react overnight. The flask is then removed from the heating mantle and allowed to cool to 40° C. The solution is filtered through a 0.2 mm Nylon filter membrane and solid is washed with warm deionized water. The solid is placed in a glass dish and air dried overnight. A portion of the formed film (0.2 g) is added with poly(methyl methacrylate) (9.8 g) in an extruder at 180° C. for 5 min to produce a well dispersed cellulose-polymer nanocomposite.

### Example 4: Sulfated CNC-PMMA

A sulfated AIBN-CNC precursor is prepared as described above in Example 1, but using an aqueous solution containing sulfated cellulose nanocrystals (50 mL, 2% by mass CNC) instead of the cellulose nanofibers. The sulfated AIBN-CNC precursor was then freeze dried for 3 days. A portion (0.05 g) of the precursor was then added to 5 g dimethyl formamide (DMF) in around bottom flask and bath sonicated for 20 min. The flask was then moved to a heating mantle, where 5 g of uninhibited methyl methacrylate and a stir bar were added. The flask was heated to 80° C. and reacted overnight. The well dispersed gel was then dispersed in 5 g of DMF and precipitated by adding the mixture dropwise to 2-butanol (500 mL) to form the sulfated CNC-PMMA nanocomposite. The nanocomposite was washed in fresh 2-butanol and oven dried at 110° C. Hot pressed samples showed good dispersion of CNC in the PMMA.

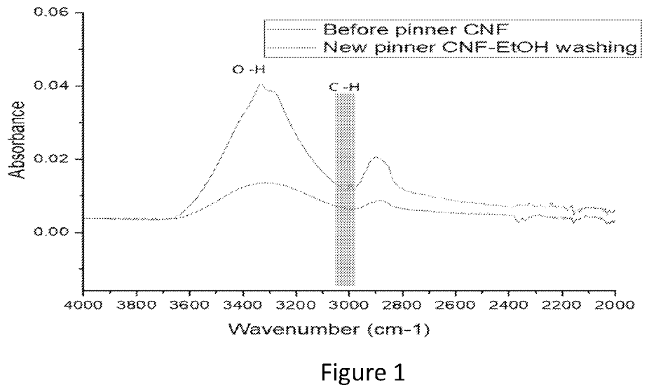

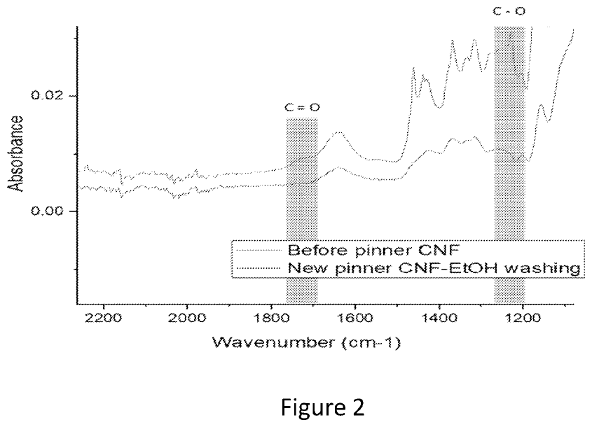

As shown in the Figures, by attaching the initiator (for example, AIBN) to the cellulose material (CNC or CNF), the way that the polymer grows off of the modified cellulose is changed. For example, as shown in FIGS. 1 and 2, Fourier-transform infrared spectroscopy (FTIR) was used to compare the absorption patterns of CNF before and after modification with the addition of the initiator using method described above. The absorption of CNF before addition the addition of the initiator is shown as the lower line in both graphs, with the modified CNF results shown as the top line. The results indicate that the modified CNF composition exhibited a higher amount of absorbance than the unmodified CNF material, but also that the CNF was successfully grafted to the AIBN initiator.

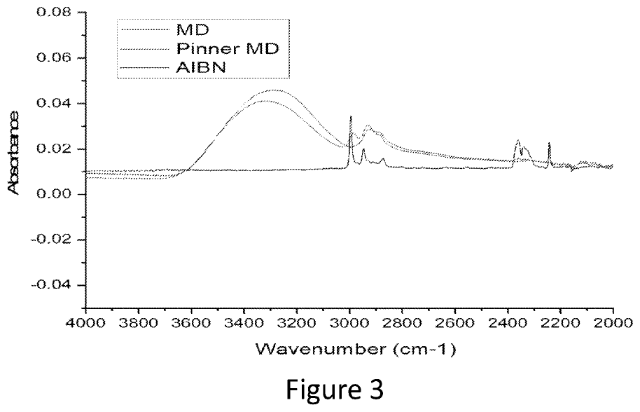

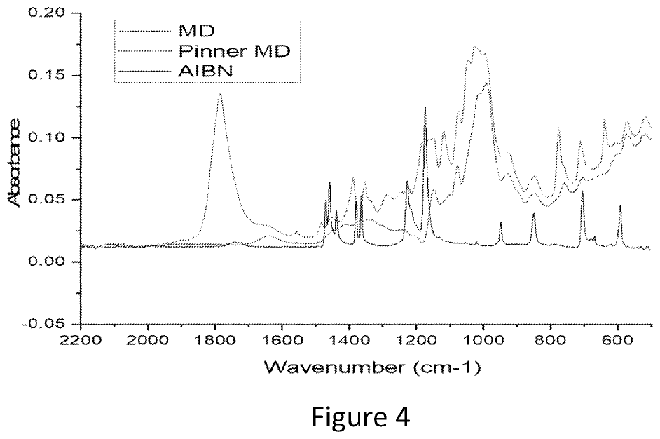

FIGS. 3 and 4 show the Fourier-transform infrared spectroscopy (FTIR) was used to compare the absorption patterns of MD before and after modification with the addition of AIBN using method described above in Example 2 and AIBN alone. The results show an increased C—H stretching of methyl group at 2900-3000 cm−1, which suggests the attachment of AIBN. So, like with the CNM, MD and presumably other cellulose materials, may also be attached or grafted to an azonitrile initiator.

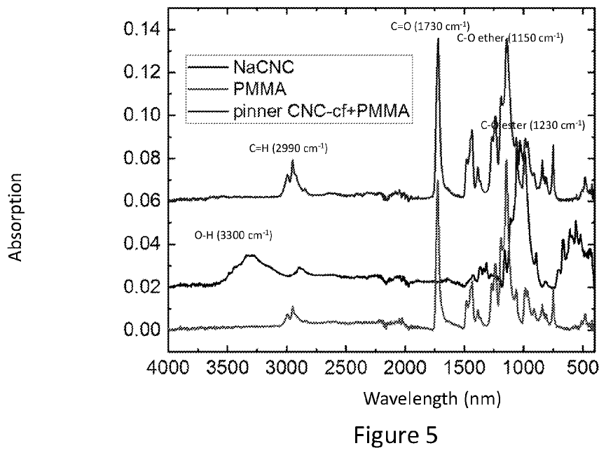

FIG. 5 shows the difference in FTIR absorbance for NaCNC, PMMA, and modified CNF-PMMA, which was prepared as described above in Example 3. The bottom line relates to the PMMA material, the middle line is NaCNC, and the top line represents the results from the modified CNC-PMMA composition.

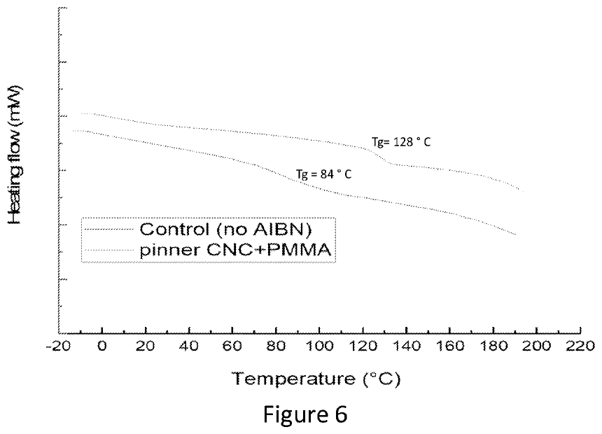

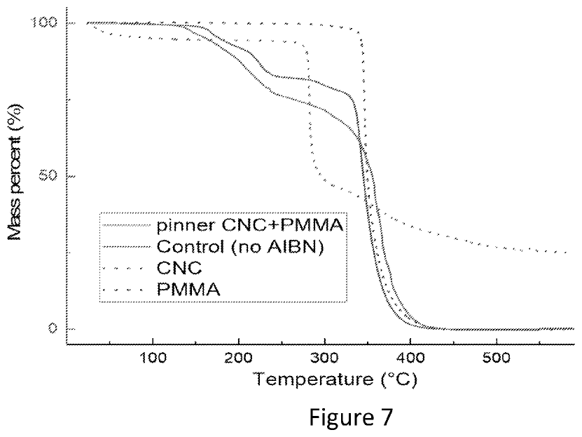

FIGS. 6-8 show the thermal properties of the PMMA-grafted CMC compared to control materials. For example, FIG. 6 shows the glass transition temperatures for both the control CNC-PMMA (no AIBN), with a Tg of 84° C. and the modified CNC-PMMA composition, prepared as described above, with a Tg of 128° C. FIG. 7 shows the mass percent of four different compositions, with the control CNC-PMMA (no AIBN) shown as the bottom solid line, the modified CNC-PMMA shown as the top solid line, the CNC alone shown as the bottom dashed line, and the PMMA alone shown as the top dashed line.

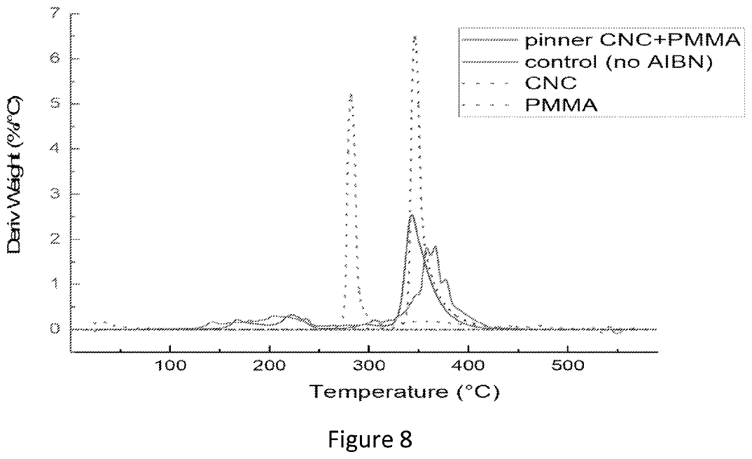

FIG. 8 shows the derivative weight loss curves for the control CNC-PMMA (no AIBN) shown as the solid line with the shorter peak at about 360° C., the modified CNC-PMMA shown as the solid line with a peak at about 340° C., the CNC alone shown as the dashed line with a peak at about 300° C., and the PMMA alone shown as the dashed line with a peak at about 340° C. It should be noted that an increase in Tg can be used to quantify the CNM-polymer interaction. As the Tg increases, the stronger the adhesion will be between the two materials.

The terminology used herein is for the purpose of describing particular embodiments only and is not intended to be limiting of the embodiments of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “comprised of,” or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept. Having described the invention in detail and by reference to the various embodiments, it should be understood that modifications and variations thereof are possible without departing from the scope of the claims of the present application.

1. A thermal, free radical initiator-grafted modified cellulose-polymer nanocomposite precursor composition comprising:
an azonitrile-based initiator grafted to a cellulose nanomaterial;
wherein the cellulose nanomaterial is selected from the group consisting of an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups.

2. The precursor composition of claim 1 where the azonitrile initiator compound is 4,4″-Azobis (4-cyanovaleric acid), 4,4′-Azobis (4-cyanopentanoic acid), 1,1′-azodi (hexahydrobenzonitrile), or 2,2′ azodi(2-methylbutyronitrile), azobisisobutyronitrile or Val-azobisisobutyronitrile.

3. A cellulose-polymer nanocomposite, wherein the nanocomposite is made by reacting a polymer monomer with a cellulose-polymer precursor comprising an azonitrile-based initiator grafted to a cellulose nanomaterial, wherein the monomer and the precursor are reacted together in an aqueous solvent, in free monomer solution, or in an extruder; and
wherein the cellulose nanomaterial is selected from the group consisting of an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups.

4. The cellulose-polymer nanocomposite of claim 3, wherein the polymer monomer a vinyl monomers, an acrylate monomers, or a combination thereof.

5. The cellulose-polymer nanocomposite of claim 4, wherein the polymer monomer is selected from butyl acrylate, methyl methacrylate, hydroxyethyl methacrylate, styrene, vinyl chloride, vinyl esters, acrylic acid, methyl acrylate, ethyl acrylate, 2-chloroethyl vinyl ether, 2-ethylhexyl acrylate, trimethylolpropane triacrylate, and combinations thereof.

6. The cellulose-polymer nanocomposite of claim 3, wherein the nanocomposite is further combined with a second polymer in a melt extruder.

7. An embodiment of claim 5, where the second polymer is polymethylmethacrylate, polystyrene, poly(lactic acid), polycarbonate, polypropylene, or poly(butylene succinate).

8. A method of making a modified cellulose-polymer nanocomposite precursor composition comprising an azonitrile-based initiator grafted to a cellulose nanomaterial, the method comprising:
combining an aqueous solution of never dried cellulose nanomaterials and an acidic solution containing an activated azonitrile initiator; and
heating the combination to form the modified cellulose-polymer nanocomposite precursor.

9. The method of claim 8, wherein the cellulose nanomaterial in solution is selected from the group consisting of an uncharged cellulose microfiber, an uncharged cellulose nanofiber or nanocrystal, a cellulose nanofiber or nanocrystal with surface carboxylic acid groups, a cellulose nanofiber or nanocrystal with surface sulfate half ester groups, a cellulose nanofiber, or a nanocrystal with surface phosphate half ester groups.

10. The method of claim 8, wherein the azonitrile initiator is 4,4′-Azobis (4-cyanovaleric acid), 4,4′-Azobis (4-cyanopentanoic acid), 1,1′-azodi (hexahydrobenzonitrile), or 2,2′ azodi(2-methylbutyronitrile), azobisisobutyronitrile or Val-azobisisobutyronitrile.

11. A thermal, free radical initiator-grafted modified cellulose-polymer nanocomposite precursor composition comprising:
an azonitrile-based initiator grafted to a carbohydrate material;
wherein the carbohydrate material is selected from the group comprising cellulose nanomaterials, cellulose, chitosan, dextrins, cyclodextrins, maltodextrins, and mixtures thereof.

12. The precursor composition of claim 1 where the azonitrile initiator compound is 4,4″-Azobis (4-cyanovaleric acid), 4,4′-Azobis (4-cyanopentanoic acid), 1,1′-azodi (hexahydrobenzonitrile), or 2,2′ azodi(2-methylbutyronitrile), azobisisobutyronitrile or Val-azobisisobutyronitrile.
